(19) United States
(12) Patent Application Publication
(10) Pub. No.: US 2019/0222925 A1
(43) Pub. Date: Jul. 18, 2019

(54) Compression-Type High-Pitch Loudspeaker Assembly with Horizontal Omnidirectional Horn Array

(71) Applicant: SHENZHEN DONGYUAN ELECTRONICS CO., LTD., Shenzhen (CN)

(72) Inventors: Haixue Ha, Shenzhen (CN); Qiaoling Tan, Shenzhen (CN); Yanjun Shen, Shenzhen (CN); Bin Liu, Shenzhen (CN)

(21) Appl. No.: 16/294,960

(22) Filed: Mar. 7, 2019

Related U.S. Application Data
(63) Continuation of application No. PCT/CN2018/072576, filed on Jan. 15, 2018.

(51) Int. Cl. H04R 1/30

(52) U.S. Cl. CPC H04R 1/30

(57) ABSTRACT

The present invention discloses a compression-type high-pitch loudspeaker assembly with a horizontal omnidirectional horn array, comprising a high-pitch loudspeaker and a horn array. A vibrating diaphragm is disposed at the top of the high-pitch loudspeaker and the center of the horn array; the horn array comprises a horn block, a top plate and a bottom plate; the vibrating diaphragm is disposed between the top plate and the bottom plate of the horn array; the horn block of the horn array is configured to connect the top plate and the bottom plate of the horn array and supports the whole structure of the horn array, and the structure of the horn array and the interior of the vibrating diaphragm of the high-pitch loudspeaker together form a throat stop portion and a throat port portion.

### CROSS REFERENCE TO RELATED APPLICATIONS

The present application is a Continuation Application of PCT Application No. PCT/CN2018/072576 filed on Jan. 15, 2018, the contents of which are incorporated herein by reference in its entirety.

### FIELD OF THE INVENTION

The present invention relates to sound box design of the electronics manufacturing field, in particular to a compression-type high-pitch loudspeaker assembly with a horizontal omnidirectional horn array.

### BACKGROUND OF THE INVENTION

With continuous advancement of the artificial intelligence technology, the development of home intelligence is getting faster and faster. Intelligent homes naturally need an intelligent home control center and an artificial intelligence assistant to communicate people's needs and control intelligent homes, helping people communicate and make transactions with third parties through the network, etc. Voice interaction is the most direct and convenient interaction way for human beings. With the breakthrough of the intelligent voice interaction technology, as sound box products have listening and speaking functions, they are honored to be selected as a best entrance for artificial intelligence by various major companies, and play the roles of the intelligent home control center and the intelligence assistant. Corresponding intelligent sound box products have rapidly emerged in the market, such as Amazon's Echo, Google's Google Home, Apple's HomePad, Microsoft's Invoke and the like. In China, Jingdong, Lenovo, Xiaomi and other enterprises also produce AI sound boxes.

From the acoustics view, an intelligent sound box mainly differs from the traditional sound box in the omnidirectional property of intelligent sound box demands. It is expected that clean and consistent sound waves are transmitted in the omnidirectional range of horizontal 360° of the sound box, which is convenient for people to have good interactive experience with the intelligent sound box anywhere at home.

The traditional omnidirectional sound box, as shown in FIGS. 1 and 2, generally employs an application manner that the direct radiation-type high-pitch loudspeaker is installed upward or downward. In practical application, a listener is in a 90° off-axis direction of a vibrating diaphragm of a loudspeaker 10, in which direction audio attenuation is serious and the high frequency performance is poor; or the traditional omnidirectional sound box employs a plurality of high-pitch or low-pitch loudspeakers (100, 200, 300 and 400) which are distributed in an encircling manner to form the distribution of a plurality of point sound sources; at any listening position around the sound box, there are distance differences and off-axis angle differences from a plurality of point sound sources to human ears, so that sound waves received by ears have phase differences and time differences, sound interference and harmonic distortion are generated, sound pressure deviations at different positions are very great, a non-uniform sound field is formed, therefore, the sound quality is not clear enough, the details are blurred and not fine enough, and the listening experience is greatly reduced. Using a plurality of high-pitch or low-pitch loudspeakers at the same time is high in cost and low in cost performance.

### SUMMARY OF THE INVENTION

In this art, a compression-type high-pitch loudspeaker assembly with a horizontal omnidirectional horn array is designed. Sound release ports (a throat port portion) of a compression chamber with the high-pitch loudspeaker assembly perform transmission in a longitude direction of the vibrating diaphragm of the high-pitch loudspeaker assembly, and are uniformly distributed around a diaphragm in a range of 360°; an inlet of the sound release channel is narrow trapezoidal, is wider close to the equator position, and is narrower close to a spherical head position; the upper and lower curved surfaces of the sound release channel are exponential-type curves, and can define the upper and lower directional angles of radiation of the sound waves. After simulation verification on the sound release channels, when the number of the sound release channels is 6/8/12, a better radiant efficiency bandwidth product can be obtained; and after simulation verification (as shown in FIG. 10), when the ratio of the area of the vibrating diaphragm to the area of the sound release port is between 5 and 15, the change of the radiation efficiency is little, but the efficiency bandwidth product will increase with increasement of a compression ratio.

In order to solve the above technical problems, the present invention is achieved using the solution as follows:

A compression-type high-pitch loudspeaker assembly with a horizontal omnidirectional horn array is provided, including a high-pitch loudspeaker and a horn array; a vibrating diaphragm is disposed at the top of the high-pitch loudspeaker and at the center of the horn array; the horn array includes a horn block, a top plate and a bottom plate; the vibrating diaphragm of the high-pitch loudspeaker is disposed between the top plate and the bottom plate of the horn array; the horn block of the horn array is configured to connect the top plate and the bottom plate of the horn array and supports the whole structure of the horn array; the structure of the horn array and the interior of the vibrating diaphragm of the high-pitch loudspeaker together form a sound release channel, including a throat stop portion and a throat port portion; the throat stop portion is located at a connection of the top plate and the bottom plate of the horn array and the vibrating diaphragm of the high-pitch loudspeaker, and a part gradually extending from the throat stop portion to the outside and located in the structure of the horn array forms the throat port portion; when the high-pitch loudspeaker broadcasts sound waves, the transmitted sound waves are compressed via the throat stop portion and then mixed via the throat port portion; and the sound waves are directionally propagated to the throat port portion along the throat stop portion, and then are sent out of the high-pitch loudspeaker assembly.

Preferably, one or a plurality of horn blocks are disposed between the top plate and the bottom plate of the horn array; the plurality of horn blocks, the top plate and the bottom plate uniformly divide the horn array into a plurality of sound release channels; the central position of the interior of the top plate of the horn array is in matching connection and contact with the vibrating diaphragm of the high-pitch loudspeaker; the interior of the top plate of the horn array is designed into a smooth curved surface and has a cross section in a concave structure; the middle structure of the top plate of the horn array gradually rises towards the outside; the bottom plate of the horn array is provided with an opening in the middle; the vibrating diaphragm of the high-pitch loudspeaker completely penetrates through the opening so as to be placed in the middle of the horn array; the internal surface of the bottom plate of the horn array gradually extends towards the outside and has a segment of smooth curved surface, such that the structure of the horn array and the interior of the vibrating diaphragm of the high-pitch loudspeaker together form the throat stop portion and the throat port portion; and the structure from the throat stop portion to the throat port portion is gradually enlarged. Such a design is beneficial for directional propagation of the sound waves.

Preferably, the cross section of the top plate of the horn array is designed into a spindle shape, the interior surface and the external surface are each in a multi-curved surface extending structure; the structure of the internal surface is focused towards the center of the top plate; and the structure of the external surface is focused towards the center of the top plate.

Preferably, the horn block of the horn array is vertical to the top plate and the bottom plate of the horn array, the vertical cross section is designed into a spindle shape and gradually reduces towards the outside along the center of the horn array, so that an inlet of the throat port portion can be trapezoidal, the throat port portion is wider close to an equator position of the horn array, and the throat stop portion is narrower close to a center position of the horn array. Such a design can effectively improve the enlargement effect of the sound waves when they are transmitted to the throat port portion through the throat stop portion.

Preferably, the high-pitch loudspeaker includes the vibrating diaphragm, an electromagnetic coil, a high-pitch bracket, a washer, a magnetic sheet and a gasket; the lower end of the vibrating diaphragm of the high-pitch loudspeaker is provided with a combined structure of the electromagnetic coil, the high-pitch bracket, the washer, the magnetic sheet and the gasket, and is fixed on a base by a plurality of terminals.

Preferably, an inlet of the sound release channel is narrow trapezoidal, is wider close to the equator position, and is narrower close to a spherical head position; and narrow trapezoidal sound release ports are uniformly distributed along the longitude direction of a semi-sphere.

Preferably, the upper and lower curved surfaces of the sound release channel are exponential-type curves; curved surfaces on left and right sides of the sound release channel are gradient curved surfaces; an outlet of the sound release channel is rectangular; the distance from sound waves radiated by points on the vibrating diaphragm close to the spherical head position to the sound release port is closer, while the distance from sound waves radiated by points on the vibrating diaphragm close to the equator position to the sound release port is farther.

An operating method of a high-pitch loudspeaker assembly is disclosed, applied to the high-pitch loudspeaker assembly. The method includes:

an electrified coil of the high-pitch loudspeaker is subjected to the action of a force in a permanent magnetic field, a voice coil pushes the vibrating diaphragm to vibrate, and the vibrating diaphragm radiates sound waves;

the sound waves radiated by the vibrating diaphragm are compressed in a narrow gap of the throat stop portion, and the air pressure becomes large, so that the radiation impedance is also increased;

compressed sound energy repeatedly oscillates in a compression chamber and then enters the sound release ports uniformly distributed in the throat stop portion, sound waves entering a single sound release port are reflected a plurality of times in the horn channel to arrive at the outlet and are radiated to the outside, the continuous horn array structure covers a horizontal range of 360°, and a uniform and stable high-frequency sound field is formed in a range of horizontal 360°±30°.

Preferably, the force applied to the electrified coil of the high-pitch loudspeaker in the magnetic field can be represented by F=BIL;

Cmme is a capacitance value of an electrical element converted from the mass Mm of a vibration system, with the expression Cmme=Mm Bl²; when the sound waves are transmitted, the vibration system generated from high pitch passing through the throat stop portion is equivalent to Cmme;

Lcme is an inductance value of an electrical element converted from an edge of the vibrating diaphragm of the high-pitch loudspeaker and air equivalent force compliance Cm, with the expression Lcme=CmBl²/Sd²; the vibrating diaphragm of the high-pitch loudspeaker vibrates to push front air; the front gap is narrow, air is compressed, and the air pressure is increased, so that the radiation impedance is also increased;

Rrme is a resistance value of an electrical element converted from the mechanical loss Rm of the coil of the vibration system of the sound waves, with the expression Rrme=Bl²/Rm;

Lfcae is an inductance representation of air equivalent force compliance of the throat stop portion; the radiation impedance of a wave front of the sound release port can be adjusted via the total area of the sound release port; when the force resistance of the vibrating diaphragm is comparable to the sound radiation resistance, the impedance matching property is good and the output efficiency is the highest;

Rrae is a resistance representation of the radiation impedance of the vibrating diaphragm of the high-pitch loudspeaker in the throat stop portion, with the expression

$${R}_{rae} = \frac{{{S}_{t} ( BL )}^{2}}{{ρ}_{0} {cS}_{d}^{2}} = \frac{{( BL )}^{2}}{{ρ}_{0} c α {S}_{d}} .$$

Preferably, an inlet of the sound release channel of the high-pitch loudspeaker is narrow trapezoidal, is wider close to the equator position, and is narrower close to the spherical head position, and the narrow trapezoidal sound release ports are uniformly distributed along the longitude direction of a semi-sphere; the upper and lower curved surfaces of the sound release channel are exponential-type curves; curved surfaces on left and right sides of the sound release channel are gradient curved surfaces; an outlet of the sound release channel is rectangular; the distance from sound waves radiated by points on the vibrating diaphragm close to the spherical head position to the sound release port is closer, while the distance from sound waves radiated by points on the vibrating diaphragm close to the equator position to the sound release port is further; the distance from the sound release channel of the horn array close to the spherical head position to a wave front of the outlet is farther, and the distance from the position close to the equator position to the wave front of the outlet is closer, so as to adjust phases of the sound waves radiated at the spherical head position and the semi-sphere position of the vibrating diaphragm and achieve stable and consistent in-phase sound waves on the wave front of the outlet.

The compression-type high-pitch loudspeaker assembly with the horizontal omnidirectional horn array integrates advantages of acoustical principles of the direct radiation-type high-pitch loudspeaker in the traditional home audio field and the directional horn compression driving head in the professional stage audio field, and employs a lotus-type radial horn array structure. In a compression field formed by the throat stop portion and the throat port portion, the sound waves are transmitted to an external free field through a camber on the surface of the compression field, and better sound quality and sound effect are realized.

### BRIEF DESCRIPTION OF THE DRAWINGS

FIG. 1 is schematic diagram 1 of the prior art;

FIG. 2 is schematic diagram 2 of the prior art;

FIG. 3 is schematic diagram 1 of a loudspeaker according to an embodiment of the present invention;

FIG. 4 is schematic diagram 2 of a loudspeaker according to an embodiment of the present invention;

FIG. 5 is schematic diagram 3 of a loudspeaker assembly of an embodiment of the present invention;

FIG. 6 is schematic diagram 4 of a loudspeaker according to an embodiment of the present invention;

FIG. 7 is a schematic diagram showing an equivalent circuit of a speaker according to an embodiment of the present invention;

FIG. 8 is curve effect diagram 1 of the prior art;

FIG. 9 is curve effect diagram 2 of the prior art; and

FIG. 10 is a curve effect comparison diagram of this art and the prior art.

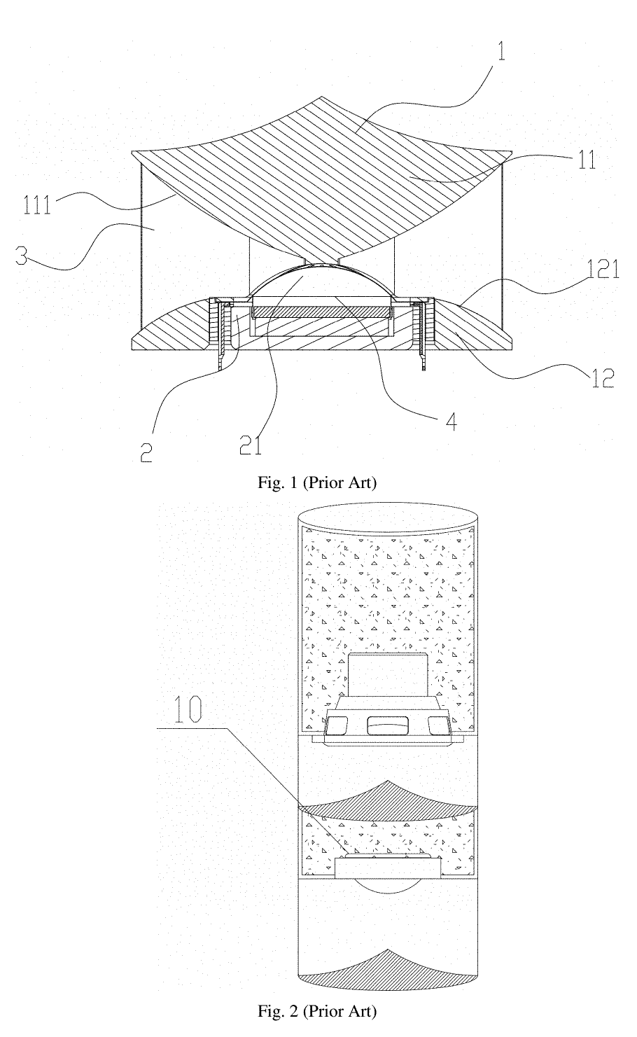

### DETAILED DESCRIPTION OF THE EMBODIMENTS

In order to make the objective, technical solution and advantages of the present invention be clearer, the present invention will be further described in detail below with reference to the accompanying drawings and embodiments. It should be understood that the specific embodiments described herein are merely used for illustration of the present invention, but are not intended to limit the present invention.

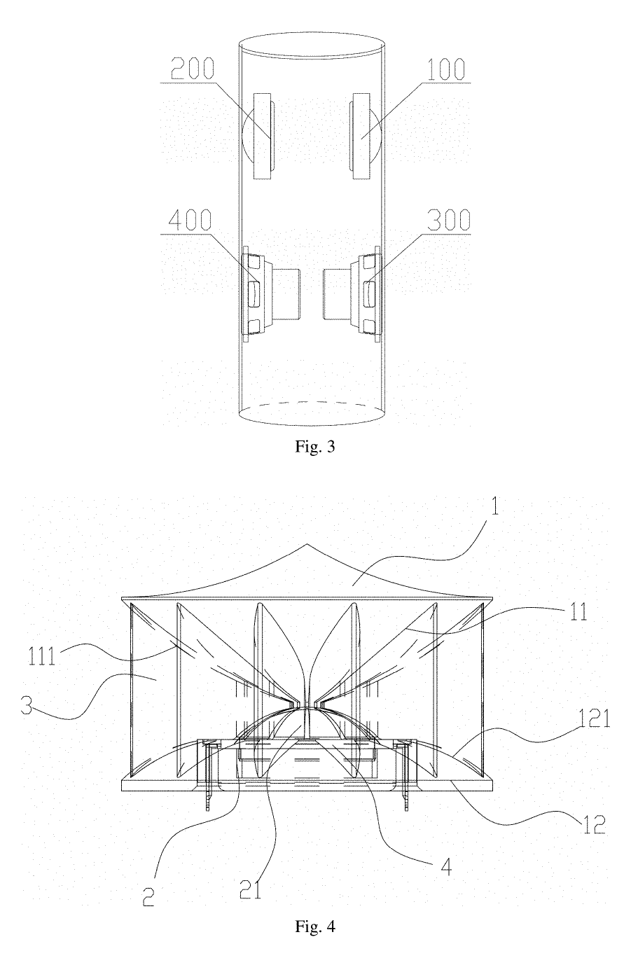

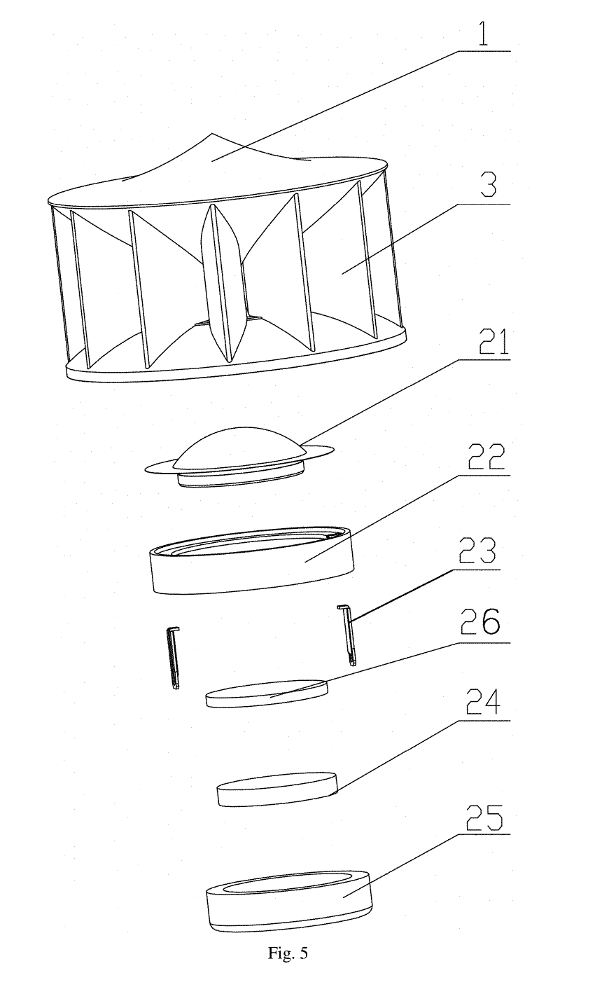

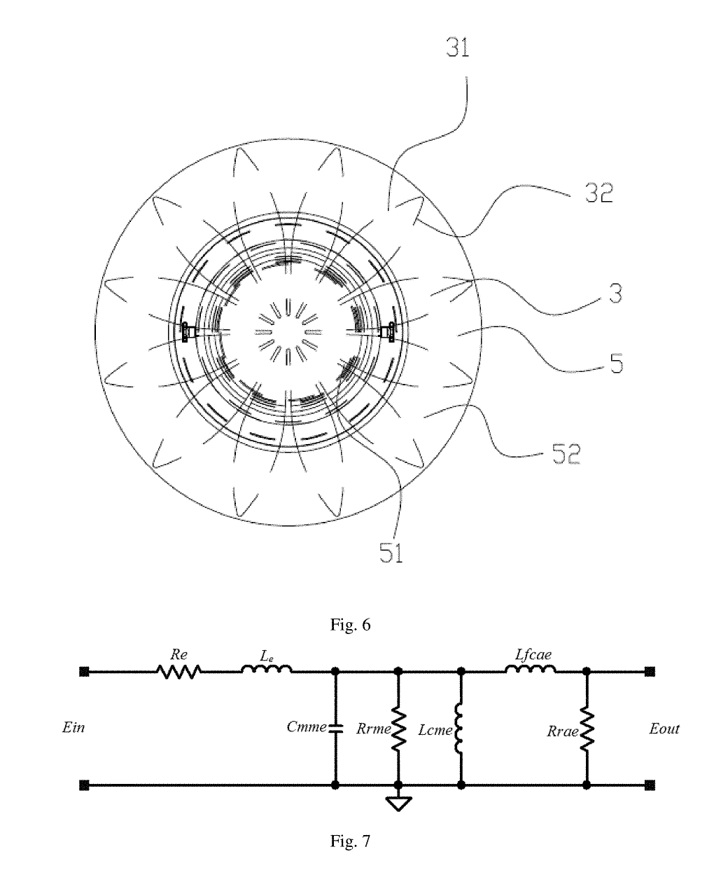

As shown in FIGS. 3-6, a compression-type high-pitch loudspeaker assembly with a horizontal omnidirectional horn array is provided, including a high-pitch loudspeaker 2 and a horn array 1; a vibrating diaphragm 21 is disposed at the top of a high-pitch loudspeaker 2 and at the center of the horn array 1; the horn array 1 includes a horn block 3, a top plate 11 and a bottom plate 12; the vibrating diaphragm 21 of the high-pitch loudspeaker is disposed between the top plate 11 and the bottom plate 12 of the horn array 1; the horn block 3 of the horn array 1 is configured to connect the horn array top plate 1 land the bottom plate 12 and supports the whole structure of the horn array 1; the structure of the horn array 1 and the interior of the vibrating diaphragm 21 of the high-pitch loudspeaker 2 form a sound release channel 5; the sound release channel 5 includes a throat stop portion 51 and a throat port portion 52; the throat stop portion 51 is located at a connection of the top plate 11 and the bottom plate 12 of the horn array 1 and the vibrating diaphragm 21 of the high-pitch loudspeaker, and a part gradually extending towards the outside from the throat stop portion 51 and located in the structure of the horn array 1 forms a throat port portion 52; when the high-pitch loudspeaker 2 broadcasts sound waves, the transmitted sound waves are compressed via the throat stop portion 51 and then mixed via the throat port portion 52; and the sound waves are directionally propagated to the throat port portion 52 along the throat stop portion 51, and then are sent out of the high-pitch loudspeaker assembly.

Preferably, one or a plurality of horn blocks 3 are disposed between the top plate 11 and the bottom plate 12 of the horn array 1; the plurality of horn blocks 3, the top plate 11 and the bottom plate 12 uniformly divide the horn array 1 into a plurality of sound release channels 5; after simulation verification on the sound release channels 5, when the number of the sound release channels 5 is 6/8/12, a better radiant efficiency bandwidth product can be obtained; the central position of the interior of the top plate 11 of the horn array 1 is in matching connection and contact with the vibrating diaphragm 21 of the high-pitch loudspeaker 2; the internal surface 111 of the top plate 11 of the horn array 1 is designed into a smooth curved surface and has a cross section in a concave structure; the middle structure of the top plate 11 of the horn array 1 gradually rises towards the outside; the bottom plate 12 of the horn array 1 is provided with an opening in the middle; the vibrating diaphragm 21 of the high-pitch loudspeaker 1 completely penetrates through the opening so as to be placed in the middle of the horn array 1; the internal surface 121 of the bottom plate 12 of the horn array 1 gradually extends towards the outside and has a segment of smooth curved surface, such that the structure of the horn array 1 and the interior of the vibrating diaphragm 21 of the high-pitch loudspeaker 1 together form the throat stop portion 51 and the throat port portion 52; and the structure from the throat stop portion 51 to the throat port portion 52 is gradually enlarged. Such a design is beneficial for directional propagation of the sound waves.

Preferably, the cross section of the top plate 11 of the horn array 1 is designed into a spindle shape, the interior surface 111 and the external surface are each in a multi-curved surface extending structure; the structure of the internal surface 111 is focused towards the center of the top plate 11; and the structure of the external surface is focused towards the center of the top plate.

Preferably, the horn block 3 of the horn array 1 is vertical to the top plate 11 and the bottom plate 12 of the horn array 1, the vertical cross section is designed into a spindle shape and gradually reduces towards the outside along the center of the horn array, so that an inlet of the throat port portion can be trapezoidal, the throat port portion is wider close to an equator position of the horn array, and the throat stop portion is narrower close to a center position of the horn array. Such a design can effectively improve the enlargement effect of the sound waves when they are transmitted to the throat port portion through the throat stop portion.

Preferably, the high-pitch loudspeaker 1 includes the vibrating diaphragm 21, an electromagnetic coil 22, a high-pitch bracket 23, a washer 24, a magnetic sheet 25 and a gasket 26; the lower end of the vibrating diaphragm 21 of the high-pitch loudspeaker 2 is provided with a combined structure of the electromagnetic coil 22, the high-pitch bracket 23, the washer 24, the magnetic sheet 25 and the gasket 26, and is fixed on a base by a plurality of terminals.

The design principle of the high-pitch loudspeaker assembly used in the present invention completely complies with an admittance lumped parameter model, and is described as follows: an electrified coil of the high-pitch loudspeaker is subjected to the action of a force in a permanent magnetic field, a voice coil pushes the vibrating diaphragm to vibrate, and the vibrating diaphragm radiates sound waves, wherein the force applied to the coil in the magnetic field can be represented by F=BIL (in which B is the magnetic field strength, I is the current intensity, and L is the wire length, and Sd is the area of the vibrating diaphragm). The sound waves radiated by the vibrating diaphragm are compressed in a narrow gap of the throat stop portion, and the air pressure becomes large, so that the radiation impedance is also increased. Compressed sound energy repeatedly oscillates in a compression chamber and then enters the sound release ports uniformly distributed in the throat stop portion, sound waves entering a single sound release port are reflected a plurality of times in the horn channel to arrive at the outlet and are radiated to the outside, the continuous horn array structure covers a horizontal range of 360°, and a uniform and stable high-frequency sound field is formed in a range of horizontal 360°±30°.

As shown in FIG. 7, Cmme is a capacitance value of an electrical component converted from the mass Mm of a vibration system, with the expression Cmme=Mm Bl² (in which B is the magnetic field strength, and l is the wire length); after using the technology, when the sound waves are transmitted, the vibration system generated from high pitch passing through the throat stop portion is equivalent to Cmme.

Lcme is an inductance value of an electrical element converted from an edge of the vibrating diaphragm of the high-pitch loudspeaker and air equivalent force compliance Cm, with the expression Lcme=CmBl²/Sd² (in which B is the magnetic field strength, l is the wire length, and Sd is the area of the vibrating diaphragm); the vibrating diaphragm of the high-pitch loudspeaker vibrates to push the front air; the front gap is narrow, air is compressed, and the air pressure is increased, so that the radiation impedance is also increased.

Rrme is a resistance value of an electrical element converted from the mechanical loss Rm of the coil of the vibration system of the sound waves, with the expression Rrme=Bl²/Rm (in which B is the magnetic field strength and l is the wire length).

Lfcae is an inductance representation of air equivalent force compliance of the throat stop portion; the radiation impedance of a wave front of the sound release port can be adjusted via the total area of the sound release port; when the force resistance of the vibrating diaphragm is comparable to the sound radiation resistance, the impedance matching property is good and the output efficiency is the highest.

Rrae is a resistance representation of the radiation impedance of the vibrating diaphragm of the high-pitch loudspeaker in the throat stop portion, with the expression

$${R}_{rae} = \frac{{{S}_{t} ( BL )}^{2}}{{ρ}_{0} {cS}_{d}^{2}} = \frac{{( BL )}^{2}}{{ρ}_{0} c α {S}_{d}} ,$$

in which B is the magnetic field strength and L is the wire length.

An inlet of the sound release channel of the high-pitch loudspeaker is narrow trapezoidal, is wider close to the equator position, and is narrower close to the spherical head position. The narrow trapezoidal sound release ports are uniformly distributed along the longitude direction of a semi-sphere, thus phases of sound waves radiated by respective points on the vibrating diaphragm can be effectively corrected. The number of the sound release ports can influence the bandwidth within which the sound waves are radiated.

The upper and lower curved surfaces of the sound release channel are exponential-type curves, and can define the upper and lower directional angles of the radiation of the sound waves. Curved surfaces on left and right sides of the sound release channel are gradient curved surfaces, instead of standard curved surfaces. An outlet of the sound release channel is rectangular. The distance from sound waves radiated by points on the vibrating diaphragm close to the spherical head position to the sound release port is closer, while the distance from sound waves radiated by points on the vibrating diaphragm close to the equator position to the sound release port is further, which will cause phase differences of sound wave transmission originally. However, the distance from the sound release channel of the horn array close to the spherical head position to a wave front of the outlet is farther, and the distance from the position close to the equator position to the wave front of the outlet is closer. By means of stimulation design, phases of the sound waves radiated at the spherical head position and the semi-sphere position of the vibrating diaphragm can be adjusted, and relatively stable and consistent in-phase sound waves on the wave front of the outlet is achieved.

The number of horn arrays depends on two points:

1. The size of the high-pitch loudspeaker can be adjusted according to the size of the sound box; when the overall size of the high-pitch loudspeaker is large, the number of the horn arrays can be increased, and otherwise, the number of the horn arrays can be reduced.

2. Angles of the right and left curved surfaces of the horn array determine the directional property of single horns, and for a multi-horn array, we should consider the problem of sound interference of sound waves radiated by adjacent horns.

The innovation of the high-pitch loudspeaker assembly in this art lies in that the high-pitch loudspeaker assembly integrates advantages of acoustical principles of the direct radiation-type high-pitch loudspeaker in the traditional home audio field and the directional horn compression driving head in the professional stage audio field, and employs a lotus-type radial horn array structure; in a compression field formed by the throat stop portion and the throat port portion, the sound waves are transmitted to an external free field through a camber on the surface of the compression field, and better sound quality and sound effect are realized.

Technical features of the high-pitch loudspeaker assembly of the present invention are as follows:

A. In terms of directional property.

As for a common direct radiation-type loudspeaker, sound waves are positively radiated towards the front of the vibrating diaphragm, and sound wave propagation is diffused in a heart shape.

As for a directional horn compression driving head, sound waves are positively radiated towards the front of the vibrating diaphragm, and are directionally radiated according to angles defined by horns after being compressed and focused.

As for the high-pitch loudspeaker assembly of the present invention, sound waves are radiated around the vibrating diaphragm in a 360° direction, and sound waves directly in the front are compressed to the periphery.

B. Sound release channels on a throat stop of a common compression driving head perform outward transmission in a latitude direction of the vibrating diaphragm of the high-pitch loudspeaker, and ring-shaped channels at equal intervals converge sound wave beams to a throat port.

Sound release ports of the compression chamber of the high-pitch loudspeaker assembly of the present invention perform transmission in a longitude direction of the vibrating diaphragm, and are uniformly distributed around the diaphragm in a range of 360°.

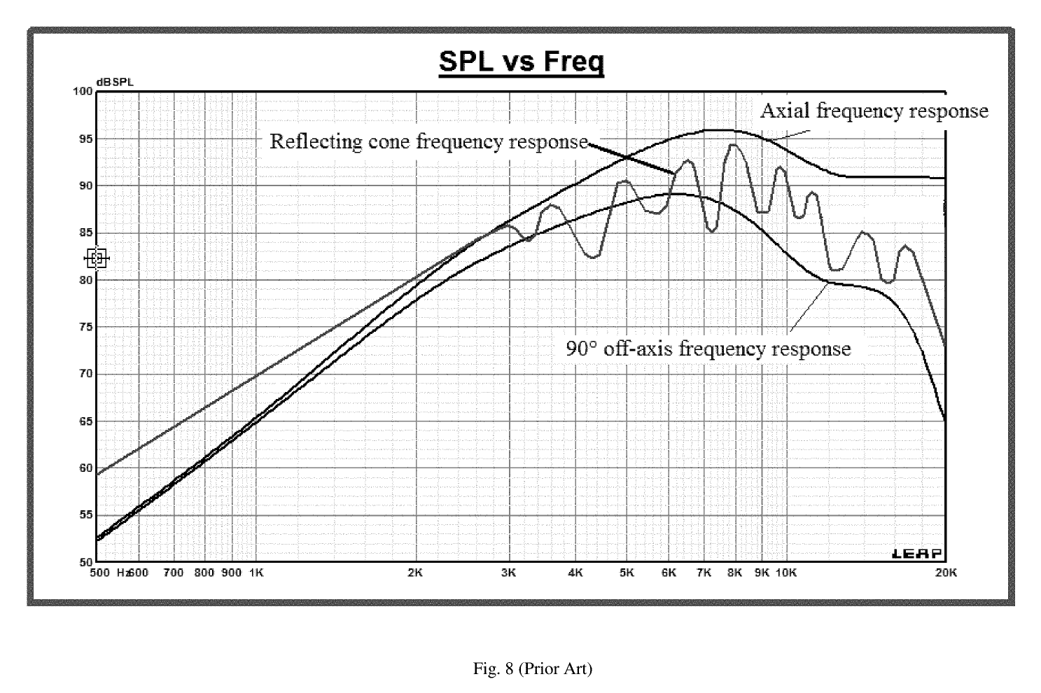

C. The sound release channels uniformly distributed on the spherical vibrating diaphragm in 360° combine phase throat stop and horn functions. An inlet of the sound release port is trapezoidal, is wider close to the equator position, and is narrower close to a spherical head position. The upper and lower curved surfaces of the sound release channel are exponential-type curves, and can define the upper and lower directional angles of the radiation of the sound waves. Curved surfaces on left and right sides of the sound release channel are gradient curved surfaces, instead of standard curved surfaces. An outlet of the sound release channel is rectangular. Due to the trapezoidal inlet and the gradient curved surfaces, phases of the sound waves radiated at the spherical head position and the semi-sphere position of the vibrating diaphragm can be adjusted, and relatively stable and consistent in-phase sound waves on the wave front of the outlet is achieved. The stimulation verification diagram is as shown in FIG. 8.

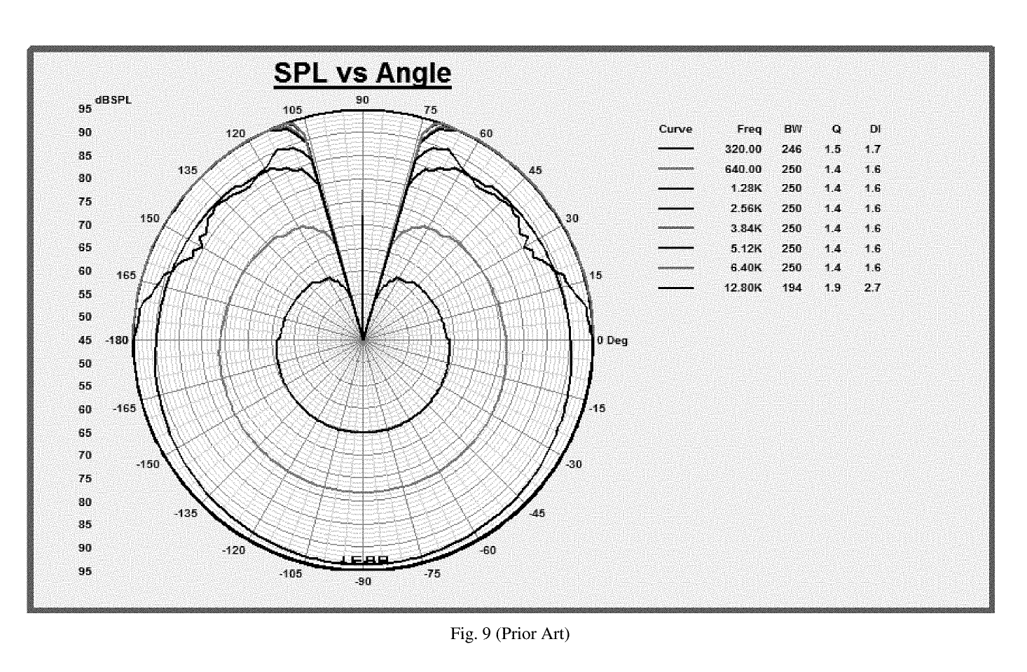

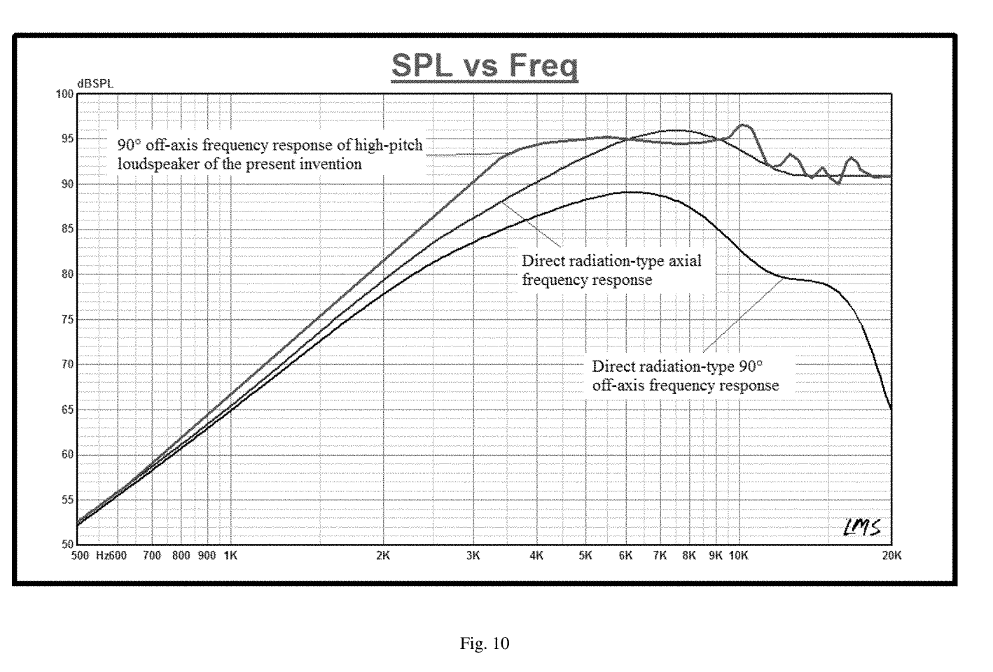

D. After simulation verification (as shown in FIG. 9), when the number of the sound release channels is 6/8/12, a better radiant efficiency bandwidth product can be obtained. The continuous horn array structure covers a horizontal range of 360°, and a uniform and stable high-frequency sound field is formed in a range of horizontal 360°±30°.

E. When the radiation impedance matches and is approximate to the load impedance, the radiation efficiency is the highest. A too high or too low radiation impedance can result in reduced efficiency.

F. After simulation verification, when the ratio of the area of the vibrating diaphragm to the area of the sound release port is between 5 and 15, the change of the radiation efficiency is little, but the efficiency bandwidth product will increase with increasement of a compression ratio.

G. The vibrating diaphragm of the high-pitch loudspeaker assembly of the present invention should be selected from vibrating diaphragms having a light and hard spherical head, such as a titanium film, an aluminum film, and a ruthenium film. Soft materials such as silk film, PEI, MYLAR material are not suitable for selection. The vibrating diaphragm of a common direct radiation-type high-pitch loudspeaker generally has a folding ring made of a soft material, but the high-pitch loudspeaker assembly of the present invention does not require the folding ring. This is because vibration in the compression chamber requires that the vibrating diaphragm is in a more uniform and stable vibration mode, but the vibrating diaphragm made of the soft material is prone to split vibration. In the bonding process of the spherical head and the folding ring, deviation is also likely to occur to cause vibration imbalance, and the vibration mode of the diaphragm distorts.

The high-pitch loudspeaker assembly of the present invention is invented for the demand on the current intelligent sound box, and mainly has the beneficial effect that the shortcoming of common poor high-frequency performance of the intelligent sound box in the current market is overcome. Of course, it can also be applied to other types of products needing the horizontal omnidirectional property. A plurality of continuous horn array structures are used to cover a horizontal range of 360°, and a uniform and stable sound field is formed in a range of horizontal 360°±30°. This is an effect that the conventional sound box at present is hard to achieve.

The high-pitch loudspeaker assembly of the present invention is simple in manufacturing process, is higher than a common direct radiation-type high-pitch loudspeaker in cost, and is cheaper than the application manner that more than two high-pitch loudspeakers are used to improve the high-frequency performance, and the cost performance is high, so that the high-pitch loudspeaker assembly of the present invention can be commonly used.

The description above is only preferred embodiments of the present invention, and is not intended to limit the present invention. Any modifications, equivalent substitutions and improvements made within the spirit and principles of the present invention are within the scope of protection of the present invention.

What is claimed is:

1. A compression-type high-pitch loudspeaker assembly with a horizontal omnidirectional horn array, comprising a high-pitch loudspeaker and a horn array, wherein a vibrating diaphragm is disposed at the top of the high-pitch loudspeaker and at the center of the horn array; the horn array comprises a horn block, a top plate and a bottom plate; the vibrating diaphragm of the high-pitch loudspeaker is disposed between the top plate and the bottom plate of the horn array; the horn block of the horn array is configured to connect the top plate and the bottom plate of the horn array and supports the whole structure of the horn array; the structure of the horn array and the interior of the vibrating diaphragm of the high-pitch loudspeaker together form a sound release channel, comprising a throat stop portion and a throat port portion; the throat stop portion is located at a connection of the top plate and the bottom plate of the horn array and the vibrating diaphragm of the high-pitch loudspeaker, and a part gradually extending from the throat stop portion to the outside and located in the structure of the horn array forms the throat port portion; when the high-pitch loudspeaker broadcasts sound waves, the transmitted sound waves are compressed via the throat stop portion and then mixed via the throat port portion; and the sound waves are directionally propagated to the throat port portion along the throat stop portion, and then are sent out of the high-pitch loudspeaker assembly.

2. The compression-type high-pitch loudspeaker assembly with a horizontal omnidirectional horn array according to claim 1, wherein a plurality of horn blocks are disposed between the top plate and the bottom plate of the horn array; the plurality of horn blocks, the top plate and the bottom plate uniformly divide the horn array into a plurality of sound release channels; the central position of the interior of the top plate of the horn array is in matching connection and contact with the vibrating diaphragm of the high-pitch loudspeaker; the interior of the top plate of the horn array is designed into a smooth curved surface and has a cross section in a concave structure; the middle structure of the top plate of the horn array gradually rises towards the outside; the bottom plate of the horn array is provided with an opening in the middle; the vibrating diaphragm of the high-pitch loudspeaker completely penetrates through the opening so as to be placed in the middle of the horn array; the internal surface of the bottom plate of the horn array gradually extends towards the outside and has a segment of smooth curved surface; the structure of the horn array and the interior of the vibrating diaphragm of the high-pitch loudspeaker together form the throat stop portion and the throat port portion; and the structure from the throat stop portion to the throat port portion is gradually enlarged.

3. The compression-type high-pitch loudspeaker assembly with a horizontal omnidirectional horn array according to claim 1, wherein the cross section of the top plate of the horn array is designed into a spindle shape, the interior surface and the external surface are each in a multi-curved surface extending structure; the structure of the internal surface is focused towards the center of the top plate; and the structure of the external surface is focused towards the center of the top plate.

4. The compression-type high-pitch loudspeaker assembly with a horizontal omnidirectional horn array according to claim 1, wherein the horn block of the horn array is vertical to the top plate and the bottom plate of the horn array, the vertical cross section is designed into a spindle shape and gradually reduces towards the outside along the center of the horn array, so that an inlet of the throat port portion can be trapezoidal, the port portion is wider close to an equator position of the horn array, and the throat stop portion is narrower close to a center position of the horn array.

5. The compression-type high-pitch loudspeaker assembly with a horizontal omnidirectional horn array according to claim 1, wherein the high-pitch loudspeaker comprises the vibrating diaphragm, an electromagnetic coil, a high-pitch bracket, a washer, a magnetic sheet and a gasket; the lower end of the vibrating diaphragm of the high-pitch loudspeaker is provided with a combined structure of the electromagnetic coil, the high-pitch bracket, the washer, the magnetic sheet and the gasket, and is fixed on a base by a plurality of terminals; and the vibrating diaphragm of the high-pitch loudspeaker has a light and hard spherical head.

6. The compression-type high-pitch loudspeaker assembly with a horizontal omnidirectional horn array according to claim 1, wherein an inlet of the sound release channel is narrow trapezoidal, is wider close to the equator position, and is narrower close to a spherical head position; and narrow trapezoidal sound release ports are uniformly distributed along the longitude direction of a semi-sphere.

7. The compression-type high-pitch loudspeaker assembly with a horizontal omnidirectional horn array according to claim 1, wherein the upper and lower curved surfaces of the sound release channel are exponential-type curves; curved surfaces on left and right sides of the sound release channel are gradient curved surfaces; an outlet of the sound release channel is rectangular; the distance from sound waves radiated by points on the vibrating diaphragm close to the spherical head position to the sound release port is closer, while the distance from sound waves radiated by points on the vibrating diaphragm close to the equator position to the sound release port is farther.

8. An operating method of a high-pitch loudspeaker assembly, applied to the high-pitch loudspeaker assembly according to claim 1, wherein the method comprises:
pushing the vibrating diaphragm to vibrate by a voice coil, and radiating sound waves by the vibrating diaphragm when an electrified coil of the high-pitch loudspeaker is subjected to the action of a force in a permanent magnetic field;
the sound waves radiated by the vibrating diaphragm being compressed in a narrow gap of the throat stop portion, and the air pressure becoming large, so that the radiation impedance is increased;
compressed sound energy repeatedly oscillating in a compression chamber and then entering the sound release ports uniformly distributed in the throat stop portion, sound waves entering a single sound release port are reflected a plurality of times in the horn channel to arrive at the outlet and are radiated to the outside, the continuous horn array structure covers a horizontal range of 360°, and a uniform and stable high-frequency sound field is formed in a range of horizontal 360°±30°.

9. The method according to claim 8, wherein the force applied to the electrified coil of the high-pitch loudspeaker in the magnetic field can be represented by F=BIL;
Cmme is a capacitance value of an electrical element converted from the mass Mm of a vibration system, with the expression Cmme=Mm Bl²; when the sound waves are transmitted, the vibration system generated from high pitch passing through the throat stop portion is equivalent to Cmme;
Lcme is an inductance value of an electrical element converted from an edge of the vibrating diaphragm of the high-pitch loudspeaker and air equivalent force compliance Cm, with the expression Lcme=CmBl²/Sd²; the vibrating diaphragm of the high-pitch loudspeaker vibrates to push front air; the front gap is narrow, air is compressed, and the air pressure is increased, so that the radiation impedance is also increased;
Rrme is a resistance value of an electrical element converted from the mechanical loss Rm of the coil of the vibration system of the sound waves, with the expression Rrme=Bl²/Rm;
Lfcae is an inductance representation of air equivalent force compliance of the throat stop portion; the radiation impedance of a wave front of the sound release port can be adjusted via the total area of the sound release port; when the force resistance of the vibrating diaphragm is comparable to the sound radiation resistance, the impedance matching property is good and the output efficiency is the highest;
Rrae is a resistance representation of the radiation impedance of the vibrating diaphragm of the high-pitch loudspeaker in the throat stop portion, with the expression
$${R}_{rae} = \frac{{{S}_{t} ( BL )}^{2}}{{ρ}_{0} {cS}_{d}^{2}} = \frac{{( BL )}^{2}}{{ρ}_{0} c α {S}_{d}} .$$

10. The method according to claim 8, wherein an inlet of the sound release channel of the high-pitch loudspeaker is narrow trapezoidal, is wider close to the equator position, and is narrower close to the spherical head position, and the narrow trapezoidal sound release ports are uniformly distributed along the longitude direction of a semi-sphere; the upper and lower curved surfaces of the sound release channel are exponential-type curves; curved surfaces on left and right sides of the sound release channel are gradient curved surfaces; an outlet of the sound release channel is rectangular; the distance from sound waves radiated by points on the vibrating diaphragm close to the spherical head position to the sound release port is closer, while the distance from sound waves radiated by points on the vibrating diaphragm close to the equator position to the sound release port is further; the distance from the sound release channel of the horn array close to the spherical head position to a wave front of the outlet is farther, and the distance from the position close to the equator position to the wave front of the outlet is closer, so as to adjust phases of the sound waves radiated at the spherical head position and the semi-sphere position of the vibrating diaphragm and achieve stable and consistent in-phase sound waves on the wave front of the outlet.
